(19) United States
(12) Patent Application Publication
(10) Pub. No.: US 2021/0016614 A1
(43) Pub. Date: Jan. 21, 2021

(54) TIRE WITH AN INTEGRATED RFID AND TPMS SENSOR

(71) Applicant: The Goodyear Tire & Rubber Company, Akron, OH (US)

(72) Inventors: John Michael Fenkanyn, Akron, OH (US); Mario Vincent Orosa, North Canton, OH (US)

(21) Appl. No.: 16/929,526

(22) Filed: Jul. 15, 2020

Related U.S. Application Data
(60) Provisional application No. 62/876,169, filed on Jul. 19, 2019.

(51) Int. Cl. B60C 23/04

(52) U.S. Cl. CPC B60C 23/0493

(57) ABSTRACT

A pneumatic tire with a radio frequency identification and tire pressure monitoring system sensor combination includes a pneumatic tire. The tire includes a pair of bead areas, a ground-contacting tread disposed radially outwardly of the pair of bead areas, a pair of sidewalls, in which each sidewall extends from a respective bead area to the tread, a carcass extending toroidally between each of the bead areas radially inwardly of the tread, and an innerliner formed on an inside surface of the carcass. An integrated RFID and TPMS sensor is mounted on the innerliner and includes an RFID tag. The RFID tag includes an integrated circuit carried on a printed circuit board. The printed circuit board is formed with at least one opening to facilitate secure mounting of the circuit board to the innerliner. The integrated RFID and TMPS sensor also includes a TPMS sensor mounted on the RFID tag.

### FIELD OF THE INVENTION

The invention relates to tires. More particularly, the invention relates to the monitoring of tire pressure and tire identification. Specifically, the invention is directed to a tire that includes a sensor with optimum mounting and structure for transmission of tire pressure data and tire identification information by radio frequency.

### BACKGROUND OF THE INVENTION

Pneumatic tires have been widely employed. Such tires include a pair of beads that are mounted on a wheel or rim. Each one of pair of sidewalls extends from a respective bead to a ground-engaging tread. A carcass, which is made of one or more plies, toroidally extends between the beads to reinforce the sidewalls and the tread. An innerliner is formed on the inside surface of the carcass. The wheel cooperates with the innerliner to define an interior or tire cavity that is inflated with air.

It has been desirable to provide such pneumatic tires with an electronic device that enables information about the tire to be transmitted to an external device for tracking of certain parameters and identification of the tire during its lifetime. One such electronic device is a radio frequency identification (RFID) device, sometimes referred to as an RFID tag.

Most RFID tags include an integrated circuit for storing and processing information and an antenna for receiving and transmitting a signal to an external reader using a radio frequency. The antenna is electronically connected to the integrated circuit and typically is carried on a substrate with the integrated circuit, such as a circuit board.

In the prior art, RFID tags were attached to the exterior of a sidewall of a pneumatic tire. The exterior of a tire sidewall provides a convenient location that enables strong transmission of the signal from the RFID tag to an RFID reader, which is separate from the tire. However, the RFID tag may incur potential damage when it is attached to the exterior of a tire sidewall. To reduce such potential damage, it has become desirable to attach the RFID tag to and interior structure of the tire. However, such interior attachment poses challenges in transmission of the signal, as the tire materials interfere with the transmission.

In addition, it is desirable to monitor certain parameters, such as the pressure in the tire cavity, the temperature in the tire cavity and/or the temperature in the tread or another tire component, and to transmit data for those parameters to a device that can record and/or display the data. To this end, tire pressure monitoring systems (TPMS) have been developed. Due to power and communication requirements of TPMS sensors, TPMS units have been separate from RFID tags. However, mounting of separate TPMS sensors and RFID tags is undesirable, particularly for tires that may be employed at high speeds. For example, high vehicle speeds, such as speeds up to 200 miles per hour (mph), result in high rotational speeds for the tire. Such high rotational speeds and accompanying increases in tire temperature due to friction require optimum mounting of any components to the tire.

Moreover, most TPMS units employ batteries to power the sensors and transmit measured data. Such use of battery power undesirably limits the range of the signal from the TPMS unit and how frequently data may be sent, as a longer range and/or more frequent transmission may severely decrease the life of the system.

As a result, there is a need in the art for a tire that includes a TPMS unit and an RFID tag which minimizes the components that are mounted to the tire, while employing an optimum structure for use at high speeds.

### SUMMARY OF THE INVENTION

According to an aspect of an exemplary embodiment of the invention, a pneumatic tire with a radio frequency identification (RFID) and tire pressure monitoring system (TPMS) sensor combination includes a pneumatic tire. The pneumatic tire includes a pair of bead areas, a ground-contacting tread disposed radially outwardly of the pair of bead areas, a pair of sidewalls, in which each sidewall extends from a respective bead area to the tread, a carcass extending toroidally between each of the bead areas radially inwardly of the tread, and an innerliner formed on an inside surface of the carcass. An integrated RFID and TPMS sensor is mounted on the innerliner and includes an RFID tag. The RFID tag includes an integrated circuit that is carried on a printed circuit board. The printed circuit board is formed with at least one opening to facilitate secure mounting of the circuit board to the innerliner. The integrated RFID and TPMS sensor includes a TPMS sensor mounted on the RFID tag.

Definitions

“Axial” and “axially” mean lines or directions that are parallel to the axis of rotation of the tire.

“Axially inward” and “axially inwardly” refer to an axial direction that is toward the axial center of the tire.

“Axially outward” and “axially outwardly” refer to an axial direction that is away from the axial center of the tire.

“Circumferential” means lines or directions extending along the perimeter of the surface of the annular tread perpendicular to the axial direction.

“Inboard” refers to the axial inner surface of the tire as mounted on the vehicle.

“Innerliner” means the layer or layers of elastomer or other material that form the inside surface of a tubeless tire and that contain the inflating fluid within the tire.

“Outboard” refers to the axial outer surface of the tire as mounted on a vehicle.

“Radial” and “radially” mean lines or directions that are perpendicular to the axis of rotation of the tire.

“Radially inward” and “radially inwardly” refer to a radial direction that is toward the central axis of rotation of the tire.

“Radially outward” and “radially outwardly” refer to a radial direction that is away from the central axis of rotation of the tire.

“RFID” means radio frequency identification.

“TPMS” means a tire pressure monitoring system.

### BRIEF DESCRIPTION OF THE DRAWINGS

The invention will be described by way of example and with reference to the accompanying drawings, in which:

FIG. 1 is a cross-sectional view of an exemplary embodiment of a pneumatic tire with an RFID and TPMS sensor of the present invention;

FIG. 2 is a top view of an exemplary integrated RFID and TPMS sensor;

FIG. 3 is a bottom view of the integrated RFID and TPMS sensor shown in FIG. 2;

FIG. 4 is a top view of the structure shown in FIG. 2 including a coating for mounting the sensor to a tire prior to curing of the tire;

FIG. 5 is a perspective view of the pneumatic tire with an RFID and TPMS sensor shown in FIG. 1, configured for mounting to the tire before tire curing, and shown prior to tire curing;

FIG. 6 is a perspective view of the pneumatic tire with an RFID and TPMS sensor shown in FIG. 5 after curing of the tire;

FIG. 7 is a perspective view of the pneumatic tire with an RFID and TPMS sensor shown in FIG. 1, configured for mounting to the tire after tire curing, and shown being encapsulated with a radio-frequency conductive compound, caulk or adhesive; and

FIG. 8 is a perspective view of the pneumatic tire with an RFID and TPMS sensor shown in FIG. 7 after curing of the radio-frequency conductive compound, caulk or adhesive.

Similar numerals refer to similar parts throughout the drawings.

### DETAILED DESCRIPTION OF THE INVENTION

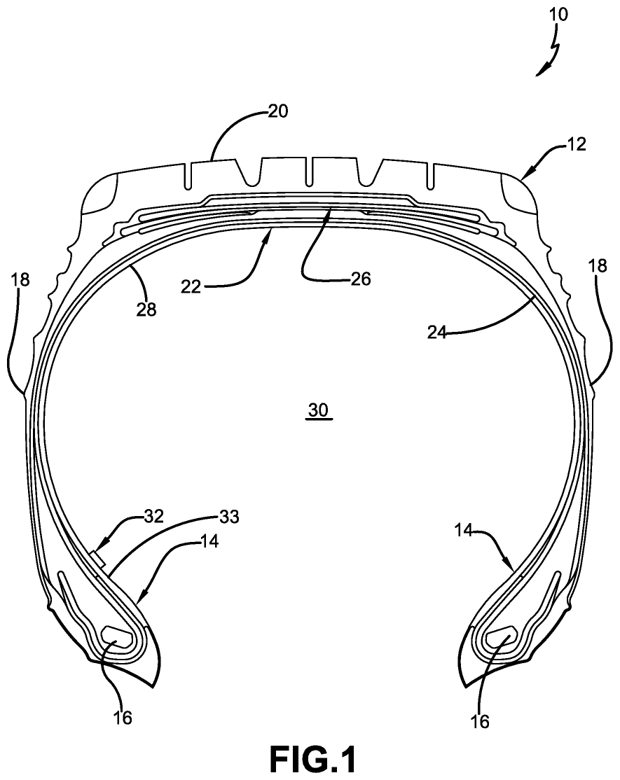

An exemplary embodiment of a pneumatic tire with an RFID and TPMS sensor of the present invention is shown in FIGS. 1 through 8 and is indicated generally at 10. Referring to FIG. 1, the invention includes a pneumatic tire 12, which in turn includes a pair of bead areas 14 and a respective bead core 16 embedded in each bead area. A respective sidewall 18 extends radially outward from each bead area 14 to a ground-contacting tread 20. The tire 12 is reinforced by a carcass 22 that toroidally extends from one of the bead areas 12 to the other one of the bead areas. The carcass 20 includes at least one ply 24 that preferably winds around each bead core 16. A belt reinforcement package 26 is disposed between the carcass 22 and the tread 20. An innerliner 28 is formed on the inside surface of the carcass 22. A tire cavity 30 is disposed inwardly of the innerliner 28. When the tire 12 is mounted on a wheel (not shown) of a vehicle, as known in the art, the innerliner 28 cooperates with the wheel to render the tire cavity 30 airtight.

An integrated RFID and TPMS sensor is indicated at 32 and is mounted on the innerliner 28 of the tire 12 as will be described in greater detail below. The RFID and TPMS sensor 32 preferably is mounted on the innerliner 28 in a lower sidewall area 33, just above the bead area 14. In this manner, the RFID and TPMS sensor 32 is disposed in the tire cavity 30.

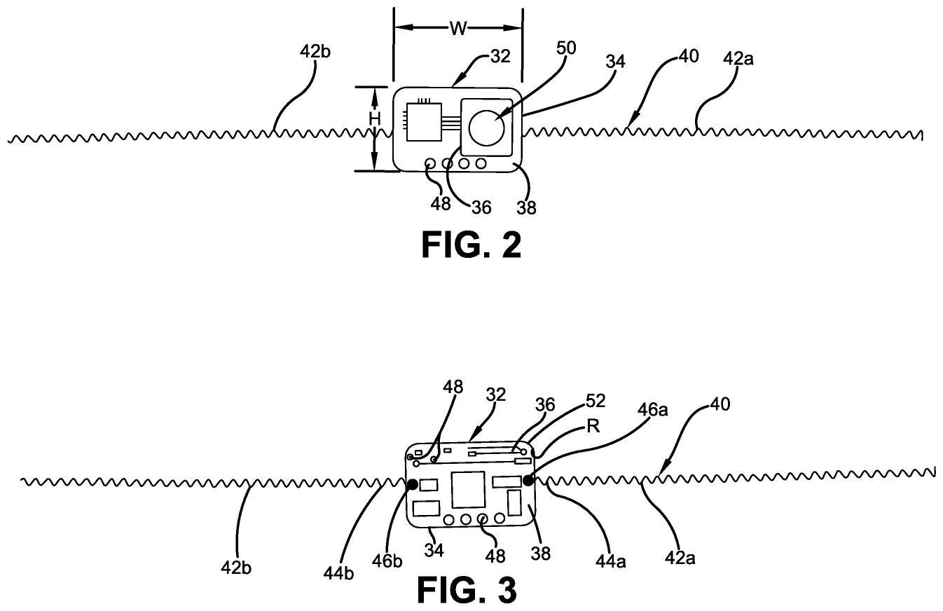

With reference now to FIGS. 2 and 3, an exemplary embodiment of the RFID and TPMS sensor 32 includes an RFID tag 34, which in turn includes an integrated circuit 36. The integrated circuit 36 is carried on a printed circuit board 38 and processes and stores data for the tire 12. More particularly, the integrated circuit 36 includes electronic memory capacity for storing identification (ID) information for each tire 12, known as tire ID information. The tire ID information may include manufacturing information for the tire 12, such as: the tire type; tire model; size information, such as rim size, width, and outer diameter; manufacturing location; manufacturing date; a treadcap code that includes or correlates to a compound identification; and a mold code that includes or correlates to a tread structure identification. The tire ID information may also include a service history or other information to identify specific features and parameters of each tire 12, as well as mechanical characteristics of the tire, such as cornering parameters, spring rate, load-inflation relationship, and the like. Such tire identification enables correlation of the measured tire parameters and the specific tire 12 to provide local or central tracking of the tire, its current condition, and/or its condition over time.

The integrated circuit 36 also modulates and demodulates a radio frequency signal for communication with an external reader (not shown) through an antenna 40. The antenna 40 includes two antenna wires 42a and 42b. Each antenna wire 42a and 42b includes a first end 44a and 44b, respectively, which is electronically connected to the integrated circuit 36 at a respective connection point 46a and 46b. At the connection point 46a and 46b, each respective antenna wire 42a and 42b is mounted to the printed circuit board 38. The antenna 40 receives and transmits a signal to the external reader using a radio frequency, thus facilitating communication between the RFID tag and the reader. Preferably, the radio frequency is an ultra-high frequency (UHF) radio frequency. In addition, each antenna wire 42a and 42b preferably is oriented to extend in a circumferential direction of the tire 12.

The printed circuit board 38 preferably is also formed with at least one opening 48, and more preferably, with a plurality of openings. The openings 48 facilitate secure mounting of the circuit board 38 and thus the RFID and TPMS sensor 32 to the tire innerliner 28, as will be described in greater detail below. To enable secure mounting of the RFID and TPMS sensor 32 to the tire innerliner 28 without compromising the integrity of the innerliner, the printed circuit board 28 also preferably includes a width W that is about 15.9 millimeters (mm) and a height H that is just over about half of the width, or about 9.2 mm. For optimum communication with an external reader, while also providing secure mounting to the tire innerliner 28, a length of each wire 42a and 42b of the antenna 40 preferably is about 36 mm.

A TPMS sensor 50 is mounted on the RFID tag 34, and thus is in electronic communication with the integrated circuit 36 and the antenna 40. The TPMS sensor 50 includes a pressure sensor that measures the pressure in the tire cavity 30. The TPMS sensor 50 may also include one or more temperature sensors that measure the temperature within the tire cavity 30 and/or another component of the tire 12. The TPMS sensor 50 may correlate the pressure and temperature measurements. Other sensors may also be mounted on the RFID tag 34, such as a stress sensor, a strain sensor, vibration sensor, accelerometer, and the like.

The integrated RFID and TPMS sensor 32 is a passive unit. More particularly, the antenna 40 communicates with an external reader through a UHF radio frequency, as described above. For optimum signal transmission, the antenna wire 42 extends in a circumferential direction of the tire 12. Such an orientation, combined with a position in the lower sidewall area 33, enables the antenna 40 to efficiently send and receive signals through the material of the tire 12. The integrated circuit 36 also includes an energy harvester, which captures and thus harvests power from an electronic field of the UHF radio frequency. The energy harvester converts the radio frequency to direct electronic current and charges a capacitor that is also included in the integrated circuit 36. Optionally, the RFID and TPMS sensor 32 may be pre-charged at a specific frequency using the antennas 46 and 48, which is turned off to enable the antennas to read the RFID and TPMS sensor. In addition, the energy harvester may alternatively capture and thus harvest optical energy, thermal energy and/or vibrational energy to charge the capacitor.

The harvested energy enables the TPMS sensor 50 to obtain power in order to take periodic pressure, temperature and/or other sensor measurements, as described above. Because the TPMS sensor 50 is mounted on the RFID tag 34, the measured data is electronically communicated to the integrated circuit 36, and may then be transmitted to the external reader by the antenna 40. In this manner, the integrated RFID and TMPS sensor 32 transmits tire ID information from the RFID tag 34 and pressure, temperature and/or other measured data from the TPMS sensor 50 to an external reader without the use of a battery.

While the circuit board 38 of the RFID and TPMS sensor 32 is roughly rectangular in shape, it preferably is formed with at least one radiused corner 52. For example, the circuit board 38 may include two or more rounded or radiused corners 52. Each radiused corner 52 preferably is formed with a radius R that is approximately one-eighth of the circuit board height H (FIG. 2). Such radiused corners 52 enable the RFID and TPMS sensor 32 to be securely mounted to the innerliner 28 of the tire 12 without compromising the integrity of the innerliner.

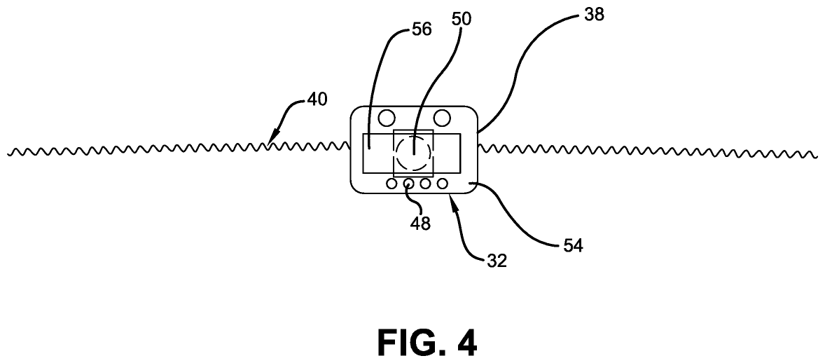

Turning now to FIGS. 4 through 6, the integrated RFID and TPMS sensor 32 may be mounted to the innerliner 28 before curing of the tire 12. In such a case, the circuit board 38 is encapsulated or coated in a rubber or polymer compound 54 that remains on the circuit board to protect the integrated circuit 36 and enhance adhesive bonding of the RFID and TPMS sensor 32 to the tire innerliner 28. The TPMS sensor 50 is covered with a temporary protective material 56, such as tape, which preserves the integrity of the pressure sensor during the curing process and may be removed after curing.

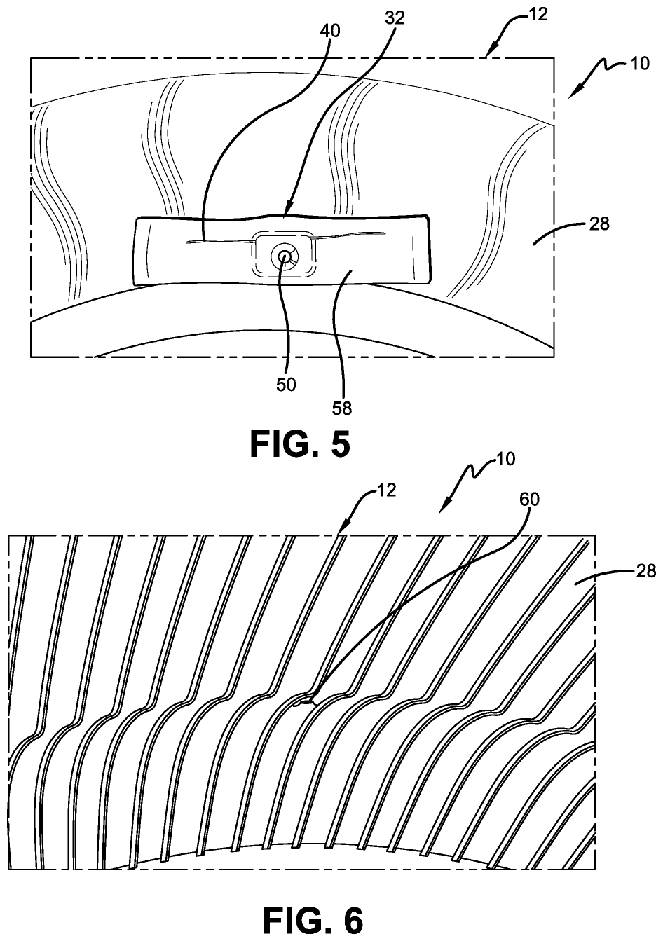

With particular reference to FIG. 5, the RFID and TPMS sensor 32 is positioned on the innerliner 28 in a lower sidewall area 33 with a strip of innerliner material 58. The strip of material 58 covers the RFID and TPMS sensor 32 to secure it to the innerliner 28. The tire 12 is then cured, securing the mounting of the RFID and TPMS sensor 32 to the innerliner 28, as shown in FIG. 6. During curing, the openings 48 in the circuit board 38 enable innerliner material 58 to pass into the structure of the circuit board and provide integrated, secure mounting of the RFID and TPMS sensor 32 to the innerliner 28. A small opening 60 is formed when the temporary protective material 56 is removed, enabling the pressure sensor of the TPMS sensor 50 to be in direct communication with the tire cavity 30 (FIG. 1). Optionally, the pressure sensor of the TPMS sensor 50 may be removed from the remainder of the RFID and TPMS sensor 32 before the tire is cured, and then re-attached to the RFID and TPMS sensor through the opening 60 after the tire is cured.

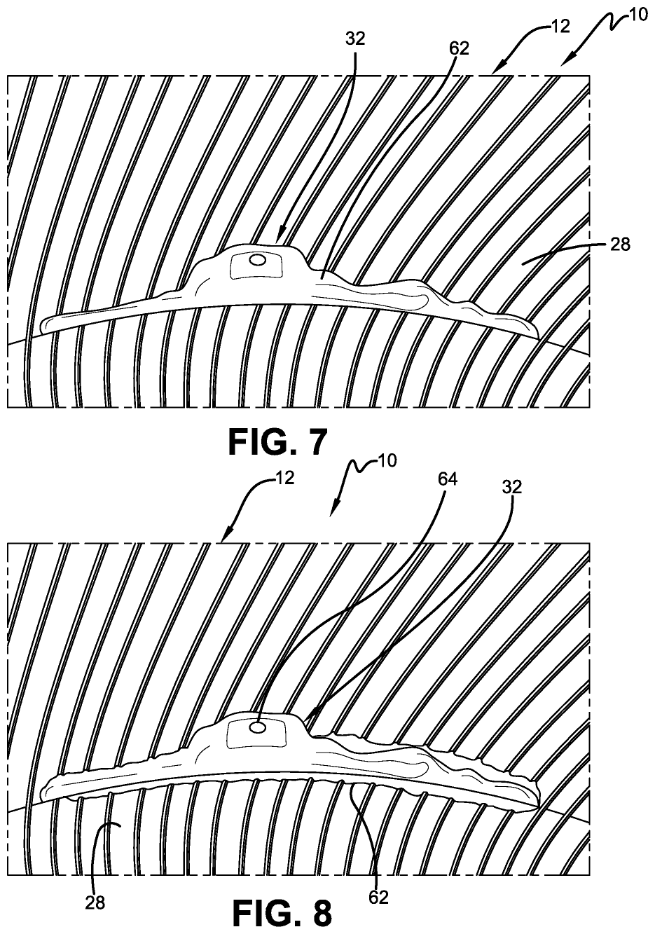

Referring now to FIGS. 7 and 8, the RFID and TPMS sensor 32 may be mounted to the innerliner 28 after curing of the tire 12. For such post-cure mounting, the innerliner 28 is cleaned. An elastomer-compatible adhesive 62, which is an appropriate adhesive that bonds effectively between the RFID and TPMS sensor 32 and the innerliner 28, is applied to the RFID and TPMS sensor. For example, a radio-frequency conductive compound, caulk or adhesive may be employed for the adhesive 62. The RFID and TPMS sensor 32 with the adhesive 62 is applied to the cleaned area of the innerliner 28, as shown in FIG. 8. Additional adhesive 62 is applied to the RFID and TPMS sensor 32 to encapsulate the sensor and secure its mounting to the innerliner 28, as shown in FIG. 8. The adhesive 62 is then allowed to cure. The openings 48 in the circuit board 38 enable the adhesive 62 to pass into the structure of the circuit board and provide integrated, secure mounting of the RFID and TPMS sensor 32 to the innerliner 28. Preferably, a small opening 64 is formed when the adhesive 62 is applied, enabling the pressure sensor of the TPMS sensor 50 to be in direct communication with the tire cavity 30 (FIG. 1).

In this manner, the pneumatic tire with an RFID and TPMS sensor 10 of the present invention employs a structure that enables operation at high vehicle speeds, such as up to about 200 mph. For example, the TPMS sensor 50 is mounted directly on the RFID tag 34 to form an integrated structure. The openings 48 formed in the circuit board 38 enhance the structural mounting of the integrated RFID and TPMS sensor 32 to the tire innerliner 28 for stability at high speeds.

The antenna wire 42 of the pneumatic tire and RFID and TPMS sensor 10 of the present invention extends in a circumferential direction of the tire, which combines with the position of the antenna 40 in the lower sidewall area 33 to enable efficient signal transmission. In addition, the small size of the circuit board 38 and its radiused corners 52 maximize available circuit board space while not compromising the innerliner 28 when increased stress and strain is incurred at high vehicle speeds. Moreover, as a passive unit that employs energy harvesting, the RFID and TPMS sensor 32 transmits tire ID information from the RFID tag 34 and pressure, temperature and/or other sensor data from the TPMS sensor 50 to an external reader without the use of a battery. Data from additional sensors that are mounted on the RFID tag 34, such as a stress sensor, a strain sensor, vibration sensor and/or accelerometer, may be transmitted to an external reader without the use of a battery.

The present invention also includes a method of forming and/or using a pneumatic tire with an RFID and TPMS sensor 10. The method includes steps in accordance with the description that is presented above and shown in FIGS. 1 through 8.

It is to be understood that the structure of the above-described pneumatic tire with an RFID and TPMS sensor 10 may be altered or rearranged, or components known to those skilled in the art omitted or added, without affecting the overall concept or operation of the invention. The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A pneumatic tire with a radio frequency identification (RFID) and tire pressure monitoring system (TPMS) sensor combination, the combination comprising:
a pneumatic tire including:
a pair of bead areas;
a ground-contacting tread disposed radially outwardly of the pair of bead areas;
a pair of sidewalls, in which each sidewall extends from a respective bead area to the tread;
a carcass extending toroidally between each of the bead areas radially inwardly of the tread;
an innerliner formed on an inside surface of the carcass;
an integrated RFID and TPMS sensor being mounted on the innerliner;
the integrated RFID and TPMS sensor including an RFID tag, the RFID tag including an integrated circuit being carried on a printed circuit board, wherein the printed circuit board is formed with at least one opening to facilitate secure mounting of the circuit board to the innerliner; and
the integrated RFID and TPMS sensor including a TPMS sensor mounted on the RFID tag.

2. The pneumatic tire with a radio frequency identification (RFID) and tire pressure monitoring system (TPMS) sensor combination of claim 1, wherein the integrated RFID and TPMS sensor is mounted on the innerliner at a lower sidewall area of the innerliner.

3. The pneumatic tire with a radio frequency identification (RFID) and tire pressure monitoring system (TPMS) sensor combination of claim 1, wherein the integrated RFID and TPMS sensor includes an antenna.

4. The pneumatic tire with a radio frequency identification (RFID) and tire pressure monitoring system (TPMS) sensor combination of claim 3, wherein the antenna includes two wires that are each electronically connected to the integrated circuit at respective connection points.

5. The pneumatic tire with a radio frequency identification (RFID) and tire pressure monitoring system (TPMS) sensor combination of claim 4, wherein each antenna wire extends in a circumferential direction of the tire.

6. The pneumatic tire with a radio frequency identification (RFID) and tire pressure monitoring system (TPMS) sensor combination of claim 1, wherein the printed circuit board is formed with at least one radiused corner.

7. The pneumatic tire with a radio frequency identification (RFID) and tire pressure monitoring system (TPMS) sensor combination of claim 6, wherein the at least one radiused corner includes a radius that is about one-eighth of a height of the printed circuit board.

8. The pneumatic tire with a radio frequency identification (RFID) and tire pressure monitoring system (TPMS) sensor combination of claim 1, wherein the integrated circuit includes electronic memory capacity for storing identification information for the tire.

9. The pneumatic tire with a radio frequency identification (RFID) and tire pressure monitoring system (TPMS) sensor combination of claim 1, wherein the TPMS sensor includes a pressure sensor.

10. The pneumatic tire with a radio frequency identification (RFID) and tire pressure monitoring system (TPMS) sensor combination of claim 1, wherein the TPMS sensor includes at least one temperature sensor.

11. The pneumatic tire with a radio frequency identification (RFID) and tire pressure monitoring system (TPMS) sensor combination of claim 1, wherein the integrated RFID and TPMS sensor is a passive unit.

12. The pneumatic tire with a radio frequency identification (RFID) and tire pressure monitoring system (TPMS) sensor combination of claim 1, wherein the integrated circuit includes an energy harvester.

13. The pneumatic tire with a radio frequency identification (RFID) and tire pressure monitoring system (TPMS) sensor combination of claim 12, wherein the energy harvester harvests power from an electronic field of an ultra-high frequency radio frequency.

14. The pneumatic tire with a radio frequency identification (RFID) and tire pressure monitoring system (TPMS) sensor combination of claim 12, wherein the energy harvester harvests at least one of optical energy, thermal energy and vibrational energy.

15. The pneumatic tire with a radio frequency identification (RFID) and tire pressure monitoring system (TPMS) sensor combination of claim 1, wherein the integrated RFID and TPMS sensor is mounted to the innerliner before curing of the tire.

16. The pneumatic tire with a radio frequency identification (RFID) and tire pressure monitoring system (TPMS) sensor combination of claim 15, wherein the circuit board is encapsulated in at least one of a rubber compound and a polymer compound.

17. The pneumatic tire with a radio frequency identification (RFID) and tire pressure monitoring system (TPMS) sensor combination of claim 15, wherein the integrated RFID and TPMS sensor is secured to the innerliner with a strip of innerliner material.

18. The pneumatic tire with a radio frequency identification (RFID) and tire pressure monitoring system (TPMS) sensor combination of claim 1, wherein the integrated RFID and TPMS sensor is mounted to the innerliner after curing of the tire.

19. The pneumatic tire with a radio frequency identification (RFID) and tire pressure monitoring system (TPMS) sensor combination of claim 18, wherein the integrated RFID and TPMS sensor is secured to the innerliner with an adhesive.

20. The pneumatic tire with a radio frequency identification (RFID) and tire pressure monitoring system (TPMS) sensor combination of claim 1, wherein at least one of a stress sensor, a strain sensor, a vibration sensor and an accelerometer is mounted on the RFID tag.
